(19) United States
(12) Patent Application Publication
(10) Pub. No.: US 2015/0151842 A1
(43) Pub. Date: Jun. 4, 2015

(54) COOLING CONCEPT COLD AIR SHOWER

(71) Applicant: SELL GMBH, Herborn (DE)

(72) Inventor: Frank Weixler, Rabenau (DE)

(21) Appl. No.: 14/413,374

(22) PCT Filed: Jun. 21, 2013
(86) PCT No.: PCT/EP2013/063054

§ 371 Date: Jan. 7, 2015

Related U.S. Application Data
(60) Provisional application No. 61/673,855, filed on Jul. 20, 2012.

(51) Int. Cl. B64D 13/08; B64D 11/04

(52) U.S. Cl. CPC B64D 13/08; B64D 11/04

(57) ABSTRACT

The invention relates to an aircraft galley (1) comprising at least one cooling compartment (2) for receiving a container for foods and/or drinks to be cooled, characterized in that at the back of the galley (1) at least one first panel (3) is mounted which is connected to an air exhaust structure (5). In the panel, at least one air exhaust duct (4) and at least one air exhaust opening (3a) oriented towards the cooling compartment (2) are provided. A second panel (6) is mounted on top of the cooling compartment (2), said panel being connected to a source of cooling air (7) and extending at least over the width of the cooling compartment (2). A plurality of cooling air openings (6a) for the specific supply of cooling air to the cooling compartment (2) are provided in the second panel (6).

### 1. FIELD OF THE INVENTION

The invention relates to an aircraft galley having at least one cooling compartment for holding one or more containers for supply goods to be cooled. Such containers can be any type of drawer boxes, trays or trolleys, as typically used in the aircraft industry for equipping galleys.

### 2. PRIOR ART

In aircraft, travelers are supplied in particular with supply goods such as beverages and food by what are known as aircraft galleys that have a plurality of compartments into which the supply goods can be placed as needed. These supply goods are typically delivered to the aircraft for each flight in so-called trolleys, these being mobile containers, and then pushed into the compartments in the aircraft galley provided for this purpose, where they are secured, if necessary, to prevent them from falling out. Those containers that contain perishable goods or the content of which is to be cooled for other reasons either have dedicated chilling units or must be cooled in another manner within the aircraft galley.

A plurality of systems are therefore already known from practice in which the cooling compartments can be cooled. However, the design of these cooling devices is typically very complex and additionally does not allow modification of the aircraft galley on short notice as a function of changing needs. Moreover, regular aspirations are being made to ensure that the cooling compartments are cooled evenly across the entire width and entire depth of the cooling compartments that in practice can only be ensured with very complex means.

### 3. SUMMARY OF THE INVENTION

It was therefore an object of the invention to create an aircraft galley that chills a compartment to be cooled using simple means that can be easily controlled and are more easily adaptable to new circumstances. This object is achieved according to the invention by an aircraft galley having the features of claim 1. Advantageous embodiments of the invention are disclosed in the dependent claims.

### 4. SUMMARY OF THE INVENTION

According to the invention, at least one first panel that is connected to an exhaust air-discharge system and in which at least one exhaust air duct and at least one exhaust air opening that opens into the cooling compartment are provided, is provided on the back of the galley. Moreover, a second panel connected to a cooling air source extends at least across the width of the cooling compartment in an upper region of the cooling compartment, multiple cooling air openings being provided in the second panel for feeding cooling air into the cooling compartment.

According to the invention, the cooling compartment is thus cooled by deliberately supplying and discharging cooling into the cooling compartment and out of the same, the cooling air flowing around the goods to be cooled in the cooling compartment, for example containers or the like, in a deliberate manner and preferably completely. The cooling air is introduced from above into the cooling compartment via the second panel for this purpose and, after the cooling air has cooled the goods to be cooled in the cooling compartment and has accordingly been heated up, is discharged as waste air through the first panel. According to the invention, a preferably continuous cooling air flow is thus maintained within the cooling compartment.

The panel-like structure of the cooling system additionally allows the cooling compartment to be cooled using particularly simple and space-saving means so as to limit the stowage space in the cooling compartment only slightly as compared to non-cooled compartments. Such a design preferably also allows the aircraft galley to be modified on short notice, for example when more or fewer cooling compartments than during the previous use of the aircraft become necessary.

In a first embodiment of the invention, it is preferred when the second panel not only extends across the entire width, but also the full depth of the cooling compartment. In this way an aircraft galley is created that allows the deliberate supply of cooling air into the cooling compartment in a planar and preferably uniform manner, essentially in the form of a cooling air waterfall that completely surrounds the goods to be cooled.

It is in particular preferred when the exhaust air openings in the first panel are provided exclusively in a lower region of the cooling compartment, preferably uniformly distributed across the width of the first panel. In this way an aircraft galley is created in which the cooling air flow flows via the second panel from above, through the entire cooling compartment, to the bottom of the cooling compartment along all the goods to be cooled, so as to thereby deliver maximal cooling power. After the cooling air has flowed over all the goods to be cooled, the exhaust air is then preferably uniformly withdrawn in a lower region of the cooling compartment via the first panel.

In particular, it is preferred when the at least one exhaust air duct in the first panel is provided on the edge of the panel. This design of the invention ensures that the heated exhaust air does not heat the panel in a planar manner, so that an influence on the cooling compartment from partial heating of the first panel remains minimized.

It is preferred in a further embodiment of the invention when the cooling air openings are uniformly distributed across the width and depth of the second panel. In this way, uniform heat input into the cooling compartment and a uniform flow around the supply goods to be cooled are ensured.

In an alternative but likewise preferred embodiment of the invention, cooling air openings in the second panel are provided at least on the edge of the second panel adjacent the front of the cooling compartment in an increased number per unit of surface area or length and/or in a larger passage area for the cooling air. In this way, cooling is created in which the front side of the cooling compartment can be cooled more strongly than the back thereof, thereby ensuring that no significant heating of the front region of the cooling compartment occurs, even when the service staff opens the cooling compartment, and any heating can be compensated for again at least as quickly as possible after the cooling compartment is closed.

In a further preferred embodiment of the invention, the first and second panels are connected to the cooling air source or to an exhaust air storage unit, preferably a heat exchanger, via flexible hoses. In this way an aircraft galley is created in which the connection of the cooling panels to external cooling air sources and exhaust air storage units can be solved particularly easily and variably. The flexible hoses can be routed in almost any arbitrary manner, and also across large distances, along the aircraft galley or other supporting structures to the chiller.

In particular, it is preferred when the cooling air is source is provided in an upper region of the aircraft galley. Moreover, it is preferred when the exhaust air treatment unit, preferably a heat exchanger, is likewise provided in an upper region of the aircraft galley. In this way an aircraft galley is created that has a particularly space-saving design and in which the connection of the cooling compartment to the supply units can be implemented in a particularly simple manner. In particular, the cooling air source can be connected to a plurality of cooling air compartments and/or panels. It is particularly preferred when a connection for the on-board supply of cooling air is provided in an upper region of the aircraft galley.

It is preferred in a further embodiment of the invention when the depth of the first panel does not exceed 4.57 cm (1.8 in), and preferably 4.32 cm (1.7 in). It is further preferred when the height of the second panel does not exceed 4.57 cm (1.8 in), and preferably 4.32 cm (1.7 in). In this way an aircraft galley is created in which the cooling space of the cooling compartment into which the supply goods can be pushed is as large as possible and restricted only marginally by the panels.

It is in particular preferred when the free depth of the cooling compartment is at least 86.36 cm (34 in). In this way an aircraft galley is created that provides a cooling compartment that is suitable for holding customary containers such as trolleys, yet provides unrestricted cooling power. In particular, the panel-like design ensures modification on short notice of a non-cooled compartment into a cooling compartment using particularly simple means.

Moreover, it is preferred when two or more cooling compartments are connected to a single first panel, preferably however each to a respective second panel. In this way an aircraft galley is made available in which the cooling air supply can be controlled separately for each cooling compartment; the exhaust air discharge, however, can be achieved with a minimum of components.

### 5. BRIEF DESCRIPTION OF THE DRAWINGS

The invention will be described in more detail below with reference to two figures, one of which shows a preferred embodiment of the invention.

FIG. 1 is an exploded view of an aircraft galley according to the invention; and

FIG. 2 is a schematic view of an assembled aircraft galley according to the invention.

### 6. DETAILED DESCRIPTION OF THE DRAWINGS

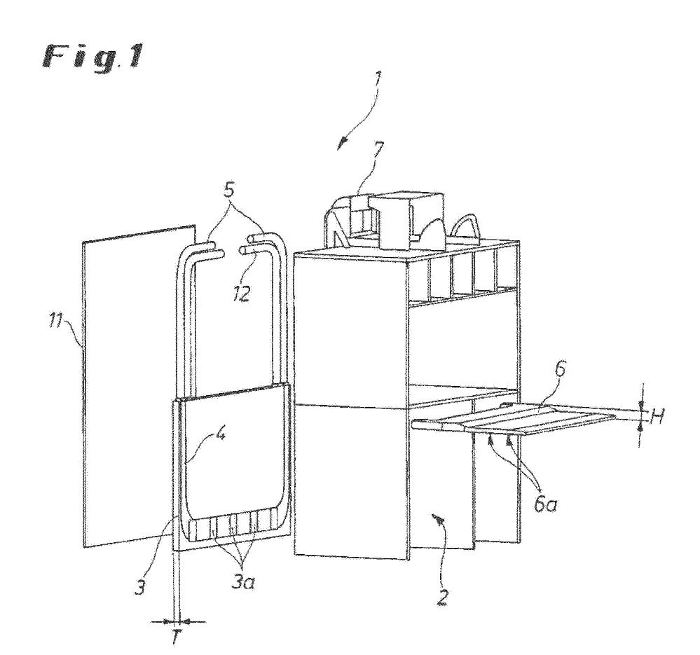

FIG. 1 is an exploded view of an aircraft galley according to the invention in which a cooling compartment 2 is provided on the bottom left. This cooling compartment 2 is used to hold an inserted trolley containing supply goods to be cooled, the trolley (not shown) having standard dimensions. A first panel 3 is provided on the back of the galley 1, between the cooling compartment 2 and a rear wall 11 closing off the aircraft galley 1, and has a plurality of openings 3a in its lower region for extracting exhaust air. This exhaust air is collected in two exhaust air ducts 4 that extend along edges of the panel 3 and that are operatively connected to hoses of an air-discharge system 5. The first panel is operatively connected to a cooling air source 7 and an exhaust air venting unit via the exhaust air-discharge system 5. The first panel 3 has a depth T of no more than 4.32 cm. Cooling air is supplied to the cooling compartment 2 via a second panel 6 whose height H also does not exceed 4.32 cm. A plurality of cooling air openings 6a are provided in a lower region of the second panel 6 and are supplied with cooling air from the cooling air source 7 to the second panel 6 via hoses 12 that is dispensed into the cooling compartment 2 in a cold air shower or waterfall-like manner. The cooling air thus runs from the top to the bottom through the cooling compartment 2 and preferably flows completely around the supply goods stored in the cooling compartment 2 until it is aspirated from the cooling compartment 2 at the bottom via the exhaust air openings 3a and removed from the cooling compartment 2 via the first panel 3.

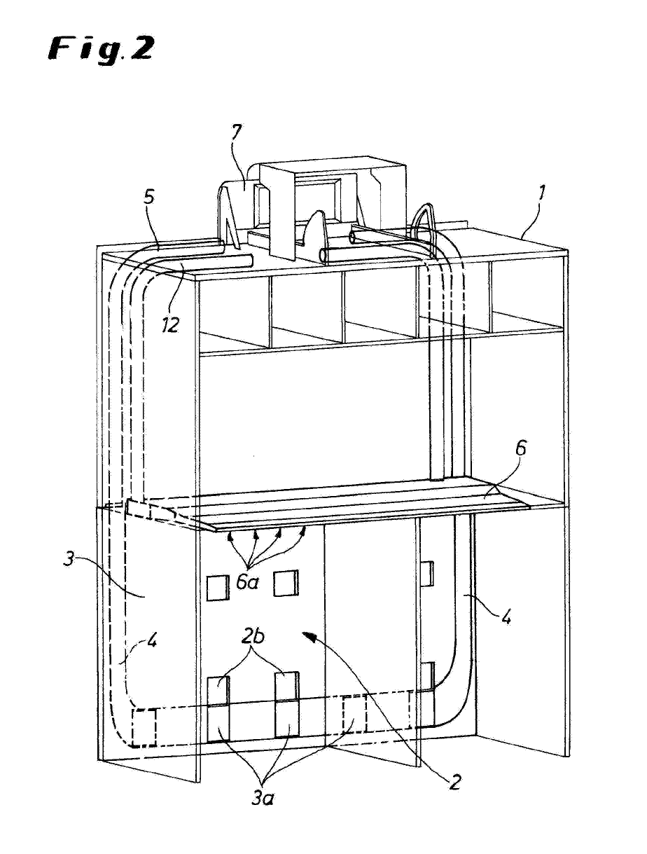

FIG. 2 shows the aircraft galley 1 according to the invention in an assembled state with the first panel 3 and the second panel 6 in the cooling compartment 2. The plurality of cooling air openings 6a provided in a lower region of the second panel 6 eject the cooling air fed from the cooling air source 7 via the cooling air supply system via of two flexible hoses 12 into the cooling compartment 2. A standardized first panel 3 can be used for a plurality of cooling compartments 2 having different widths, for example as shown where the first panel 3 covers two neighboring compartments of the aircraft galley 1, however a second panel 6 is provided exclusively above the cooling compartment 2. Suitable sealing means on the openings 3a are provided to ensure the unimpaired discharge of exhaust air and to prevent undesirable leakage.

List of reference numerals:

| | |
|---|---|
| 1 | aircraft galley |
| 2 | cooling compartment |
| 3 | panel |
| 3a | opening |
| 4 | exhaust air duct |
| 5 | hose-like exhaust air-discharge system |
| 6 | panel |
| 6a | cooling air opening |
| 7 | cooling air source |
| 11 | rear wall |
| 12 | hose |

1. An aircraft galley comprising:
a housing forming at least one cooling compartment for holding a container for supply goods to be cooled;
at least one first panel connected to an exhaust air-discharge system and having at least one exhaust duct and at least one exhaust air opening that opens into the cooling compartment on the back of the galley, and
a second panel connected to a cooling air source, extending at least across the width of the cooling compartment, in an upper region of the cooling compartment, and formed with multiple cooling air openings for feeding cooling air into the cooling compartment.

2. The aircraft galley according to claim 1, wherein the second panel also extends the full depth of the cooling compartment.

3. The aircraft galley according to claim 1, wherein the exhaust air openings in the first panel are provided exclusively in a lower region of the cooling compartment distributed across the width of the first panel.

4. The aircraft galley according to claim 1, wherein the at least one exhaust air duct in the first panel is provided on the edge of the panel.

5. The aircraft galley according to claim 1, wherein the cooling air openings are uniformly distributed across the width and depth of the second panel.

6. The aircraft galley according to any one of claims 1 to 4, claim 1, wherein the cooling air openings are provided at least on the edge of the second panel adjacent the front of the cooling compartment in an increased number per unit of surface area or length or in a larger passage area for the cooling air.

7. The aircraft galley according to claim 1, wherein the first panel and the second panel are connected to the cooling air source and an exhaust air storage unit by flexible hoses.

8. The aircraft galley according to claim 1, wherein the cooling air source is provided on the top or on the bottom of the aircraft galley.

9. The aircraft galley according to claim 1, wherein the depth of the first panel does not exceed 4.57 cm.

10. The aircraft galley according to claim 1, wherein the height of the second panel does not exceed 4.57 cm.

11. The aircraft galley according to claim 1, wherein the free depth of the cooling compartment is at least 86.36 cm.

12. The aircraft galley according to claim 1, wherein two or more cooling compartments are connected to a single first panel, each to a respective such second panel.
